(19) United States
(12) Patent Application Publication
(10) Pub. No.: US 2008/0163773 A1
(43) Pub. Date: Jul. 10, 2008

(54) Inking Systems of a Printing Press and Method for Operating an Inking System

(75) Inventors: Georg Schneider, Wurzburg (DE); Michael Heinz Fischer, Wurzburg (DE)

Correspondence Address: JONES, TULLAR & COOPER, P.C., P.O. BOX 2266 EADS STATION, ARLINGTON, VA, 22202, US

(73) Assignee: KOENIG & BAUER AKTIENGESELLSCHAFT D-97010 FREIDRICH-KOENIG-STR. 4, WURZBURG (DE)

(21) Appl. No.: 11/883,387

(22) PCT Filed: Feb. 15, 2006
(86) PCT No.: PCT/EP06/50961

§ 371 Date: Aug. 1, 2007

(30) Foreign Application Priority Data
Mar. 23, 2005 (DE) 102005014060.2

(51) Int. Cl. B41F 31/26

(52) U.S. Cl. 101/349.1; 101/483

(57) ABSTRACT

An inking system of a printing press is utilized for inking a printing cylinder. The inking system is configured as a long roller inking system and includes two distributing cylinders that are disposed serially in a roller train. A first one of these distributing cylinders is mounted, in the roller train, close to the printing cylinder. The other of these distributing cylinders is mounted, again in the roller train, further away from the printing cylinder. The printing cylinder is rotationally force-driven by an angle position controlled drive motor. One of the two distributing cylinders of the inking system is rotationally force-driven by a drive motor that is mechanically independent of the drive for the printing cylinder. The other one of the two distributing cylinders is rotationally driven by frictional engagement with adjacent rollers or cylinders. It is thus configured without a mechanical drive connection to one of the drive motors other than the frictional engagement with the adjacent roller or cylinders which are intended to rotationally drive it.

### CROSS-REFERENCE TO RELATED APPLICATIONS

This application is the U.S. National Phase, under 35 USC 371, of PCT/EP2006/050961, filed Feb. 15, 2006; published as WO 2006/100158 A2 and A3 on Sep. 28, 2006, and claiming priority to DE 10 2004 014 060.2, filed Mar. 23, 2005, the disclosures of which are expressly incorporated herein by reference.

### FIELD OF THE INVENTION

The present invention is directed to inking units of a printing press and to methods for operating an inking unit. The inking unit is configured as a single train roller inking unit with two distribution cylinders that are arranged in series in the roller train. One distribution cylinder is close to or proximate the forme cylinder while the other is more distant or remote from the forme cylinder.

### BACKGROUND OF THE INVENTION

In WO 03/039872 A1, an inking unit for a printing press is described. Two distribution cylinders of that inking unit are mechanically coupled to each other and are rotationally actuated via a shared first drive motor. These two distribution cylinders are placed in oscillating motion together via a second drive motor that is different from the first drive motor.

DE 44 30 693 A1 describes a drive for an inking unit. The distribution cylinders of the inking unit are either coupled to one another and are actuated via a shared, angular position-controlled drive motor, or are rotationally actuated separately, each via its own drive motor. In one embodiment, under actuation conditions, in which the requirements for synchronization, such as, for example, of the web tension elements or of the distribution cylinders, are not too high, speed- or torque-controlled electric motors can also be used.

DE 100 44 860 A1 describes an inking unit which is comprised of four distribution cylinders. Three of the distribution cylinders are rotationally actuated by a positive coupling with a rotational drive. One distribution cylinder is rotationally actuated solely via friction.

DE 101 57 243 A1 describes a drive for a distribution cylinder. A rotative motion of the cylinder is generated via a first, preferably speed-controlled electric motor. An oscillating motion of the distribution cylinder is generated via a second, preferably angle-controlled motor by the use of a difference in the rotational speeds.

DE 102 19 903 A1 describes a drive for a distribution cylinder, in which both rotative and translational motion can be generated by the provision of a special arrangement of coil windings. By acting unevenly upon two windings, which are arranged axially side by side, uneven torque is generated, thereby resulting in movement in an axial direction. The axial and angular positions are then reported back to the control system via a position sensor.

### SUMMARY OF THE INVENTION

The object of the present invention is to provide inking units for a printing press, which inking units are improved in terms of their cost and/or their ink transfer; and to provide methods for operating these inking units.

The object is attained in accordance with the present invention.

The benefits to be achieved by the present invention consist especially in that the inking unit allows ink motion to be improved by enabling a nearly uninterrupted rolling of the rollers which are engaged against one another in the area of the roller train that is near the forme cylinder. At the same time, decreased wear and tear and/or reduced energy consumption and/or reduced expenditures on control assemblies can be achieved.

It is advantageous, in accordance with the present invention, that the distribution cylinder which is positioned close to the forme cylinder is not drive connected to a drive motor, and is instead rotationally actuated solely via frictional contact with interacting rollers. This close distribution cylinder thus executes no rotational motion that is forced via a mechanical drive connection with a drive motor. The distribution cylinder that is distant from the forme cylinder receives rotary drive energy via a mechanical coupling with a drive motor, in addition to the frictional actuation via the rollers.

In a further advantageous improvement of the subject invention, the inking unit and/or the roller train of the inking unit can be configured as a modular component with its own side frame. The drive for the inking unit can also be configured as a transmission module with a separably connected drive motor, and can be separably connected to the inking unit frame outside of the printing press.

### BRIEF DESCRIPTION OF THE DRAWINGS

Preferred embodiments of the present invention are illustrated in the accompanying drawings and will be described in greater detail below.

The drawings show in:

FIG. 1 a schematic side elevation view of a printing unit in accordance with the present invention; in

FIG. 2 an enlarged side elevation view of a blanket-to-blanket printing unit in a planar configuration; in

FIG. 3 a preferred embodiment of an inking unit drive; in

FIG. 4 a partial section of the inking unit drive of FIG. 3; in

FIG. 5 a cross-sectional view of the journal clamp depicted in FIG. 3; in

FIG. 6a) a first position of the inking unit drive; and in

FIG. 6b a second position of the inking unit drive.

### DESCRIPTION OF THE PREFERRED EMBODIMENTS

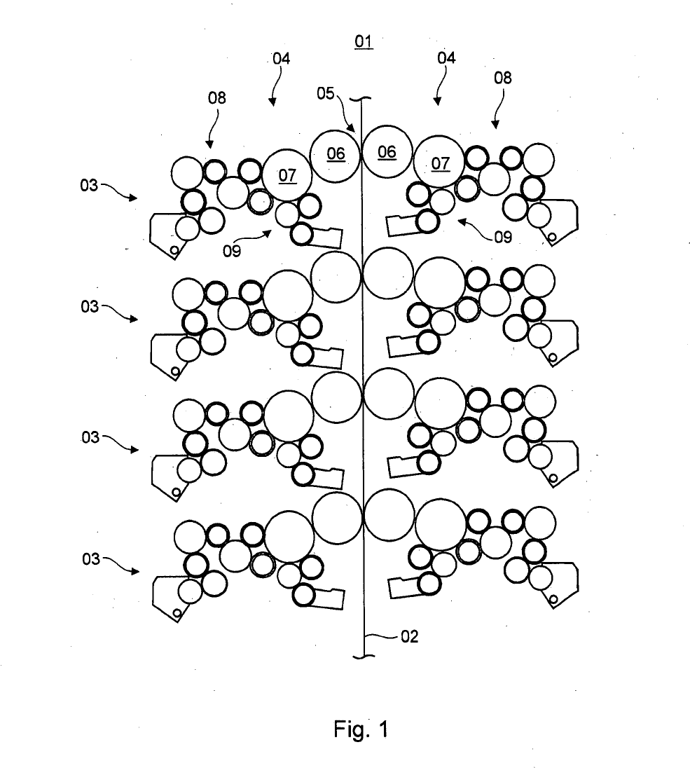

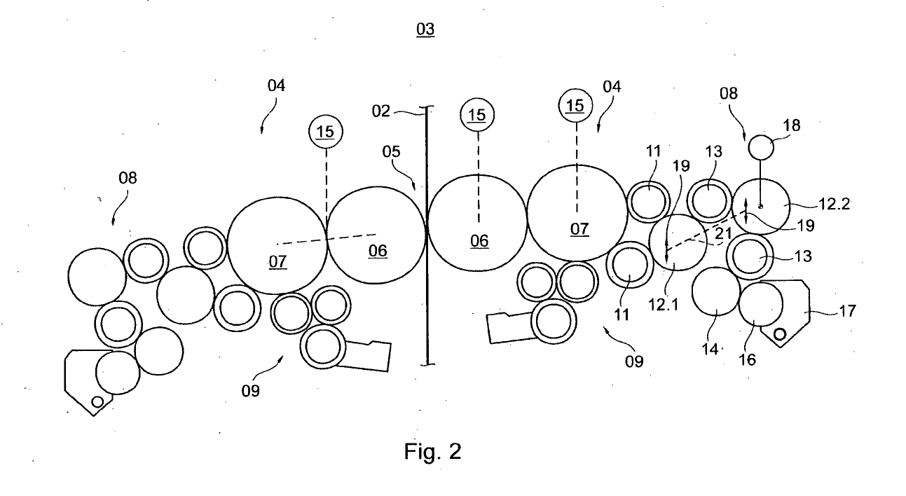

A printing press, such as, for example, a web-fed rotary printing press, and especially a multicolor web-fed rotary printing press, has, as depicted schematically in FIG. 1, a printing unit 01, in which a web of material 02, referred to here as a web 02, can be printed on both sides in a single process or, especially can be printed successively, in a multi-step process, such as, for example, in this case a four-step process, or in which multiple webs can be printed simultaneously in a single process or in a multi-step process. The printing unit 01 has multiple, and in the depicted example, has four blanket-to-blanket printing units 03 which are arranged vertically one above another for printing on both sides in a blanket-to-blanket operation. The blanket-to-blanket printing units 03, represented in FIG. 1 in the form of arch-type printing units or n-printing units, are each formed by two printing groups 04, each of which printing groups has cylinders 06; 07, one configured as a transfer cylinder 06 and one configured as a forme cylinder 07, for example printing group cylinders 06; 07, and one inking unit 08, and in the case of wet offset printing, also a dampening unit 09. In each case, between the two transfer cylinders 06, at a position of adjustment, blanket-to-blanket printing position 05 is formed. The above-named component parts are identified only on the uppermost blanket-to-blanket printing unit 03 in FIG. 1. The several blanket-to-blanket printing units 03; 04, which are arranged one above another can be, essentially identical in configuration, especially in terms of the embodiment of the features that are relevant to the present invention. In contrast to the representation in FIG. 1, the blanket-to-blanket printing units 03 can be implemented just as advantageously, without the beneficial feature of the linear arrangement, which will be described below, as a U-shaped unit that is open toward the top or as a planar printing unit 03 as represented in FIG. 2, i.e. wherein the rotational axes of the printing unit cylinder 06; 07 lie within the same plane in the print-on position.

The forme and transfer cylinders 07; 06 are preferably each configured with, for example, a cylinder width of at least two, and for example with a width of four or even six, vertical print pages which are arranged side by side in newspaper format, and especially in broadsheet format. In one embodiment, at least the forme cylinders 07 can, for example, each have a circumference that corresponds essentially to two print pages arranged in tandem in newspaper format. In another embodiment, the circumference of at least the forme cylinder can correspond to a single print page of this type.

The forme cylinder 07 is preferably rotationally actuated via an angular position-controlled drive motor 15, as may be seen in FIG. 2. As is indicated, by way of example on the right side of FIG. 2, the two cylinders 06; 07 of the printing group 04 can each have their own drive motor 15 which motor 15 is provided as a separate drive, without a mechanical drive connection to other cylinders. In an embodiment that is shown on the left side of FIG. 2, the cylinder pair, comprised of forme cylinder 07 and interacting transfer cylinder 06, can also be configured as a driven pair via a shared drive motor, and without a mechanical drive connection to other cylinders or cylinder pairs. The paired actuation of the drive for cylinders 06, 07 can act on the forme cylinder or on the transfer cylinder 06; 07, and can then be implemented on the respective other cylinder 07; 06 via a coupling which is not specifically shown.

The inking unit 08, which is characterized, for example, as a single-train roller inking unit 08 or as a “long inking unit”, has multiple rollers 11; 12; 13; 14; 16. The inking unit 08 which is depicted in FIG. 2 comprises at least two rollers 11, and especially two forme or application rollers 11, that apply the ink to the printing forme of the forme cylinder 07. The printing forme on the forme cylinder 07 receives the ink from an ink fountain 17, through an ink feed or metering system via a first oscillating roller 12.1, and especially via a first distribution cylinder 12.1, which for example, is provided with a hard surface, and which is near the printing forme or forme cylinder. A roller 13, and especially an ink or transfer roller 13, such as, for example, a roller 13 with a soft surface, contacts both the first distribution cylinder and a second oscillating roller 12.2, especially a distribution cylinder 12.2, which is positioned distant from the forme cylinder. An additional or second ink or transfer roller 13, for example one with a soft surface, contacts a roller 14, and especially a film roller 14 which, in turn, engages a roller 16, especially one provided as an ink fountain roller or dipping roller 16. Ink fountain and film rollers 16; 14, characteristic of a film inking unit, can also be advantageously replaced by a different kind of ink supply or metering system, such as, for example, a pump system in an ink injector system, or a vibrator system in a vibrator inking unit. In the above-described single-train inking unit 08, an ink transport path branches off, or splits, from the ink infeed system, as viewed in the direction of the forme cylinder 07, at the earliest, if at all after the first distribution cylinder 12.1 that is positioned closest to the forme cylinder. In other words, there are no parallel ink application paths that also have a distribution cylinder.

The soft surfaces of the application rollers and/or of the transfer rollers 11; 13, referred to in short as the soft rollers 11; 13, are resilient in a radial direction. For example they may be constructed with a rubber layer, which is indicated in FIG. 2 by the concentric circles.

When the rollers 11; 12; 13; 14 of the inking unit 08 are engaged against one another, the hard surfaces of the respective first and second distribution cylinders 12.1; 12.2 dip into the soft surfaces of the respective interacting soft rollers 11; 13 to a greater or lesser degree, based upon engagement pressure between the rollers and/or the adjustment path of these rollers. This engagement causes the circumferential ratios of interacting rollers 11; 12; 13; 14 to change, depending upon the roller impression depth, as the several rollers roll against one another.

If, for example, one of the multiple interacting rollers in the roller inking unit 08 is forced into rotational actuation based upon a preset speed, such as, for example, via a drive motor or a corresponding mechanical drive connection to another actuated component, then an adjacent soft roller that is actuated solely by virtue of friction with the former roller will rotate at a different speed based upon the impression depth of the first roller. However, if this soft roller were to also be actuated by its own drive motor, or additionally were to be driven via friction resulting at a second nip point, and by another speed-controlled roller, then, in a first case, this could result in a difference between the motor-driven preset speed of the drive roller and the speed generated by friction of the second roller, and in a second case, it could result in a difference between the two speeds which are both generated by friction. This will result in roller slippage at the nip points and/or will result in unnecessary strain on the drive motor or motors.

In the area of the inking unit 08 near the forme cylinder, and especially in the area of the application of ink by the application rollers 11 onto the printing forme, with the solution to be described below, and in accordance with the present invention, a slip-free rolling or “true rolling” and a slip-free or true rolling inking are achieved.

The first distribution cylinder 12.1, which is situated near the forme cylinder, is rotationally actuated solely via friction with the adjacent application roller 11 and the first transfer roller 13. It has no additional mechanical drive connection to the drive for the printing group cylinders 06; 07, or to another inking unit roller that is forced into rotational actuation, or to its own separate drive motor for executing its rotational actuation. In this manner, the first distribution cylinder 12.1 is rotationally actuated predominantly via the, in this example, two, or optionally also one or three forme application rollers 11 that are actuated via friction with the forme cylinder 07, and thus essentially has the circumferential speed of the forme cylinder 07, regardless of the impressions at the nip points that lie between them. The second distribution cylinder 12.2 that is distant from the forme cylinder, as indicated in FIG. 2, has a drive motor 18 that actuates it rotationally. This second distribution cylinder 12.2, aside from the friction gearing which is formed by the rollers 12.2; 13; 12.1, has no mechanical coupling with the first distribution cylinder 12.1. The second distribution cylinder drive motor 18 is mechanically independent from the drive motor 15 that drives the forme cylinders 07. In cases involving more than two distribution cylinders 12.1; 12.2, such as, for example, with three distribution cylinders, the two such distribution cylinders that are distant from the forme cylinder can be forced, or driven into rotational actuation, alternatively, only the center distribution cylinder 12.2, or the one of the distribution cylinders that is farthest from the forme cylinder, can be forced, or driven into rotational actuation.

Preferably, both of the distribution cylinders 12.1; 12.2 have an oscillation or a friction gearing 19 that is symbolized in FIG. 2 by respective double arrows.

In an embodiment of the present invention that is mechanically less complicated, the first distribution cylinder 12.1 that is near the forme cylinder has its own oscillation gearing 19 that converts only its rotational motion into an oscillating motion. This oscillation gearing 19 can advantageously be configured as a cam mechanism, in which, for example, an axial stop that is fixed to the frame interacts with a curved, peripheral groove which is secured to the roller. Alternatively, an axial stop, that is fixed to the roller, interacts in a peripheral groove of a cam disk, which is fixed to the frame. In principle, this oscillation or friction gearing or transmission 19, that converts the cylinder rotation to an oscillating axial linear stroke, can be implemented as another suitable gearing transmission 19, such as, for example, as a worm gear or as a crank mechanism that is equipped with an eccentric.

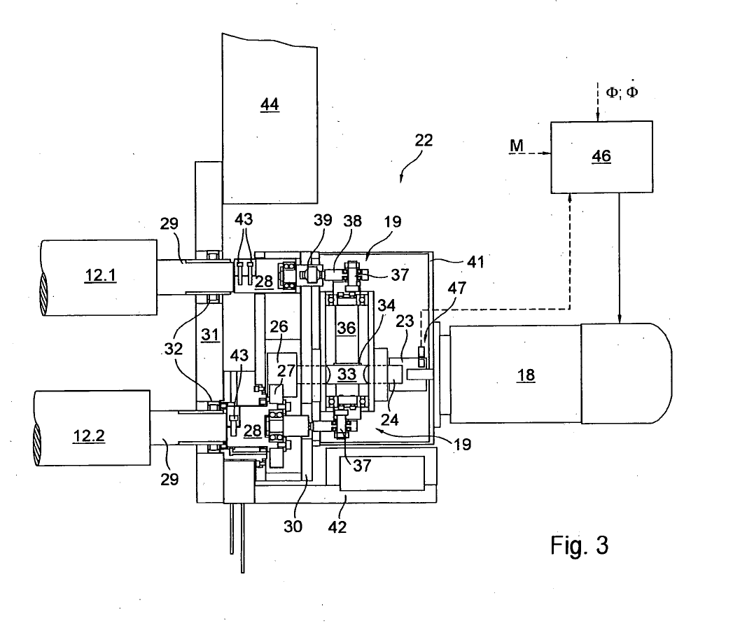

As depicted in FIG. 2 by a dashed line connecting the two double arrows, the oscillation gearing 19 of the first distribution cylinder 12.1 is advantageously mechanically coupled to the oscillation gearing 19 of the second distribution cylinder 12.2 via a transmission 21. The two coupled oscillation gearings 19 advantageously represent a shared oscillation drive or a shared oscillation gearing 22 and are force actuated, in terms of their oscillating motion, via a drive motor. The forced actuation of the oscillation gearing 22 is preferably accomplished via the drive motor 18 that rotationally actuates the second distribution cylinder 12.2, which drive motor 18 is seen more clearly in FIG. 3.

In FIG. 3, an advantageous embodiment of the present invention, for the actuation of the distribution cylinders 12.1; 12.2 is illustrated. Only the second distribution cylinder 12.2 is driven or forced into rotational actuation. Both distribution cylinders 12.1, 12.2 are driven or forced into axial actuation via the shared oscillation drive 22 as will now be further discussed.

The drive motor 18 acts on a drive sprocket 26, via a coupling 23 by way of a shaft 24. The drive sprocket 26, in turn, interacts with a spur gear 27 that is non-rotatably connected to the second distribution cylinder 12.2. This connection can be made, for example, on a journal 29 of the second distribution cylinder 12.2, via an axle section 28, which axle section 28 supports the spur gear 27. A corresponding axle section 28 of the first distribution cylinder 12.1 has no such spur gear 27 and has no drive connection to the drive motor 18. The drive connections between the drive sprocket 26 and the spur gear 27 of the second distribution cylinder 12.2 are preferably evenly toothed and are configured with a tooth engagement that has sufficient overlap to accommodate for each position of the oscillating motion of the second distribution cylinder 12.2. The two distribution cylinders 12.1; 12.2 are mounted in a side frame 31 in bearings 32, such as, for example, in radial bearings 32, which radial bearings 32 also enable axial movement. There is no rotational drive connection between the drive motor 18 and the first distribution cylinder 12.1. The drive sprocket 26 and the spur gear 27, which is arranged on the axle section 28, together form a transmission, and specifically form a speed-reducing transmission, for rotational actuation, which transmission forms a unit that can be enclosed and/or can be preassembled and which has its own housing 30. At its output side, the unit can be coupled with the journals 29.

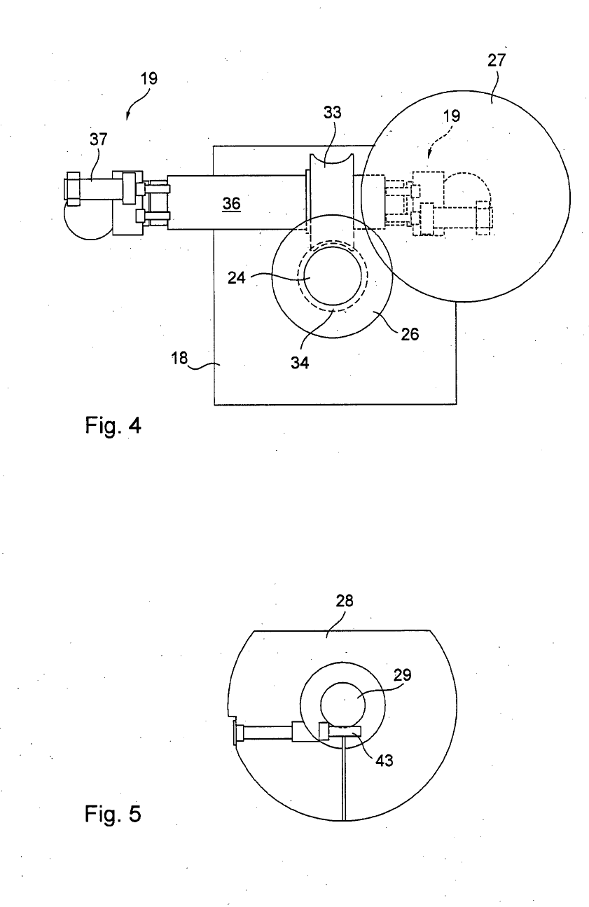

The oscillation drive 22 is also actuated by the drive motor 18, such as, for example, via a worm gear 33, 34. In this configuration, actuation of the oscillation drive 22 is accomplished via a worm 33 which is arranged out of the shaft 24 or via a section of the shaft 24 which is configured as a worm 33 on a worm gear 34, and which is non-rotatably connected to a shaft 36 that extends perpendicular to the rotational axis of the distribution cylinder 12.1; 12.2. In each case, a drive 37 is arranged on the end surface of the shaft 36, and is also arranged eccentrically to the rotational axis of the shaft 36, which driver 37 is, in turn, connected, rigid with respect to pressure and tension in the axial direction of the distribution cylinders 12.1; 12.2, to the journals 29 of the distribution cylinders 12.1; 12.2. Such a connection may be, for example, via a crank mechanism, such as, for example, via a lever 38 that is rotatably mounted on the driver 37, and a joint 39. In FIG. 4, the friction gearing 19 of the second distribution cylinder 12.2, that is distant from the forme cylinder, is indicated only by a dashed line, as in this view this friction gearing 19 is covered by the spur gear 27. A rotation of the shaft 36 causes the driver 37 to rotate, which, in turn, effects the linear travel of the distribution cylinder 12.1; 12.2 via the crank drive, as depicted in FIG. 3. The output of the oscillation gearing 22 can also occur at another point in the rotational drive train between the drive motor 18 and the distribution cylinder 12.2, or even on a corresponding oscillation gearing 22, on the other side of the machine from the journal 29 that is located at the other end surface of the distribution cylinder 12.2. A transmission, other than a worm drive 33, 34, can also optionally be provided for decoupling the axial drive.

As is shown in FIG. 3, the oscillation drive 22 or the oscillation gearing 22 is configured as a complete structural unit which is provided with its own housing 41, which oscillation gearing 22 can also be implemented as an encapsulated unit. The oscillation gearing 22 can be lubricated in the encapsulated space with oil, but preferably it is lubricated with a grease. The oscillation gearing 22 is supported, in the embodiment shown in FIG. 3, by a mount 42 that is connected to the frame 31. The drive motor 18 is separably connected to the housing 41 of the oscillation gearing 22.

FIG. 5 shows an advantageous embodiment of a non-rotatable connection between the axle section 28 and the respective journal 29. In this embodiment, rotation involves frictional contact, which is produced by a clamping of a tapered section of the journal 29 by the slotted axle section 28 that encompasses it. The position of a clamping screw 43 is measured such that viewed crosswise to the rotational axis of the journal 29, it dips or extends at least partially into a peripheral groove in the journal 29. Thus, with respect to an axial direction, it represents a positive securing of the connection.

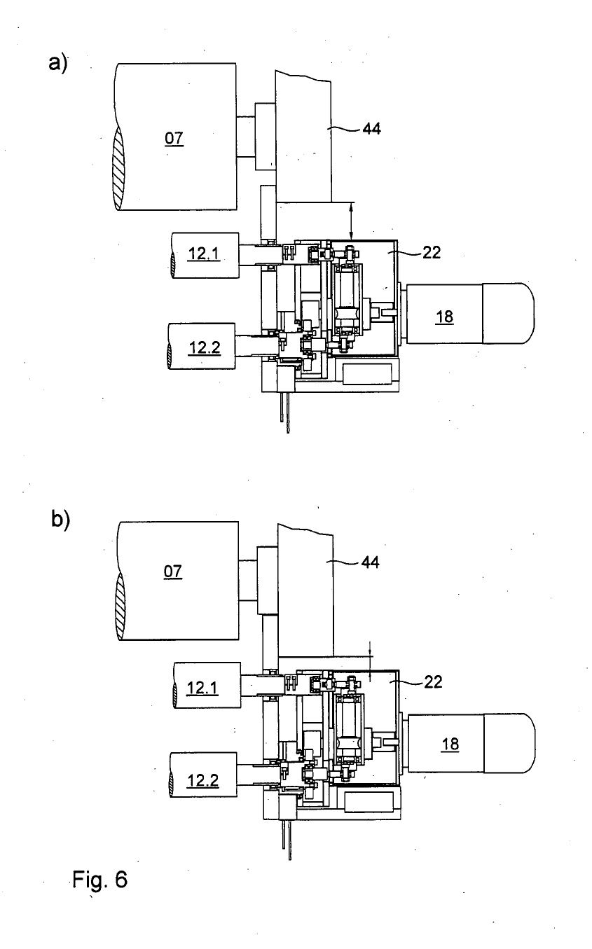

With reference to FIG. 6, a further advantageous development of the present invention is depicted and will be described. The distribution cylinders 12.1; 12.2, including their associated rotational and axial drive, are arranged on their own side frame 31, which side frame 31 is structurally different from the side frame 44 that supports the printing group cylinders 06; 07, and which is provided in the manner of a module that can be preassembled and/or can be moved. A second frame side that supports the distribution cylinders 12.1; 12.2 at their other end surface is not shown in FIG. 6. These side frames 31 that support the distribution cylinders 12.1; 12.2 and their drive can be positioned on the side frame 44 based upon the size and geometric arrangement of the printing group cylinders 06; 07. FIG. 6a) and FIG. 6b) show a position of the side frames 31 and 44 relative to one another, using one larger forme cylinder in FIG. 6 a) and one smaller forme cylinder 07 in FIG. 6 b). A distance, which is indicated by the double arrow in each of FIG. 6 a) and FIG. 6 b), between the side frame 44 and the inking unit drive, and in this case the oscillation gearing 22, is then different, based upon the position of the inking unit 08 that is implemented in the manner of a module. In this manner, printing units 01 having printing group cylinders 06; 07 with different circumferential formats can be operated in a simple manner using the same inking unit 08.

The transmission unit, which is preferably preassembled as a module, such as from an axial gearing and/or oscillation gearing 22, can be completely pre-assembled as a sub-unit for the inking units 08 that are implemented, for example, as a module. In an advantageous embodiment, the transmission unit can be pre-mounted on the side frame 31 of the inking unit module before being installed in the printing unit 01. Modularity also allows the installation/replacement/exchange of the transmission unit that is implemented as a module if the inking unit module has already been installed in the machine.

Because the first distribution cylinder 12.1 that is near the forme cylinder has no forced rotational actuation, the rollers 11, 13 roll against one another largely without slip, at least in the area of the inking unit that is near the forme cylinder.

In principle, the drive motor 18, that rotationally actuates the second distribution cylinder 12.2, can be configured as an electric motor which can be controlled or regulated with respect to its output and/or with respect to its torque and/or also with respect to its speed. In the latter case, if the drive motor 18 is being operated in a speed-regulated/controlled manner, even in print-on, then, in the area of the inking unit 08 that is distant from the forme cylinder, the aforementioned problems involving the different effective roller circumferences can still occur.

With respect to the previously discussed set of problems involving a preset speed competing with the friction gearing, however, the drive motor 18 is advantageously configured such that it can be controlled or can be regulated in terms of its output and/or its torque, at least during the printing operation in print-on position. In contrast to speed or to angular position control, in this case a torque is preset as the command variable or as the target value, rather than a speed that is to be maintained or a preset angular position. However, this preset variable does not correspond to a solely short-term and constantly changing preset variable within a speed or an angular position control loop in the ms range for the purpose of regulating a preset angular position or a preset speed. Instead, it is a fixed preset variable, which is to be maintained over an extended period of time, in other words over a period of time lasting multiple roller revolutions, without overlapping a speed or an angular position control loop. For example, during a printing operation in the print-on position, up to an optional monitoring for a maximum speed, in order to protect the motor 18, the drive motor 18 is operated, at least within certain limits, at a free speed, i.e. without a preset speed. “Free speed” in this case means that the drive motor can be operated either without any specified speed, or in any case with a monitoring of an upper and/or lower speed limit.

Preferably, the drive motor 18 is regulated or is controlled in terms of its torque, since the preset torque is independent of the speed, which is essentially determined by the friction gearing.

This operation that is controlled/regulated in terms of its output and/or its torque can, in principle, be implemented by the use of a drive motor 18 which is configured as a synchronous motor 18 or as an asynchronous motor 18. If the drive motor 18 is configured as a synchronous motor 18, regulation, in this embodiment, is focused on maintaining a current/torque constant in order to maintain a preset torque, or in the case of control, the constant is firmly preset. If the drive motor 18 is configured as an asynchronous motor 18, phase relationships between the reactive current and active current are also taken into account via calculation.

Various embodiments of the present invention are presented in what follows.

In a first embodiment of the present invention, which is the simplest in terms of expenditure, the drive motor 18 is configured as an asynchronous motor 18, for which only one frequency, for example in print-off for the inking unit 08, and/or one electrical drive output or one torque, in print-on for the inking unit 08 is preset in an allocated drive control unit 46. When the inking unit 08 is in print-off, or in other words, when the application rollers 11 are out of rolling contact with the forme cylinder 07, the inking unit 08 can be placed in a circumferential speed that is suitable for the print-on position through use of the second distribution cylinder 12.2, using a preset frequency, at which speed the circumferential speeds of the forme cylinder 07 and of the application rollers 11 differ by less than 10%, and especially differ by less than 5%. This limit advantageously also applies as a condition for the print-on position in the embodiments which are set forth below. A preset frequency or output or torque, which is suitable for this, can be determined empirically and/or through a calculation which has been performed beforehand, and can be stored either in the drive control itself, in a machine control, or in a data processor of a control center. The preset value can preferably be changed by the operator in a procedure which advantageously also applies to the preset values listed below.

In the print-on position, or in other words when the application rollers 11 are in rolling contact with the forme cylinder 07, and all the inking rollers are engaged against one another, the rollers 11; 12.1; 13; 12.2; 13; 14 are rotationally actuated, in part, by the forme cylinder 07 via the friction gearing which is now produced between the rollers 11; 12.1; 13; 12.2; 13; 14. The drive motor 18 thus need only apply the decreased power that continues to decrease in the friction gearing with its increasing distance from the forme cylinder 07. In other words, the drive motor 18 can be operated at a low drive torque or at a low drive power, which contributes only to holding the rear area of the inking unit 08 at the circumferential speed that is predetermined essentially by the frictional contact. In a first variation, this driving output can be held constant for all production rates, or speeds of the forme cylinder 07 and can correspond either to that preset value for starting up in print-off, or can represent its own constant value for production. In a second variation, for different production rates, and optionally also for starting up in print-off, different preset values, with respect to frequency and/or driving output, can be predetermined and stored. Depending upon the production rate, or the production speed, the preset value for the drive motor 18 can then vary.

In a second preferred embodiment, in addition to the drive control unit 46 and the asynchronous motor 18 of the first embodiment, the drive also has a rotational speed reset feature. In the operational phase, in which the inking unit operation is in print-off, the drive motor 18 can essentially be synchronized with the speed of the assigned forme cylinder 07 or of the printing group cylinder 06; 07. In this second embodiment, a sensor 47, such as, for example, an angular sensor 47, which is configured to detect actual speed, can be arranged on a rotating component, such as, for example, on a rotor of the drive motor 18, the shaft 24, the shaft 28, or the journal 29, which is non-rotatably connected to the distribution cylinder 12.2. In FIG. 3, an angular sensor 47 that is equipped with a rotating initiator and a stationary sensor 47 is represented, by way of example, on the coupling 23. The signal of that sensor 47 is transmitted, via a signal connection that is represented by a dashed line, to the drive control 46 for further processing. With the rotational speed resetting, a comparison with a speed M that represents the machine speed, and a corresponding adjustment of the preset output or frequency value, a slip in the momentum of the print-on position can be prevented or at least can be minimized to a few percent. In a print-on operation, the drive motor 18 can then preferably be operated, no longer strictly according to the above-described rotational speed resetting, but essentially according to the above-described preset frequency or output values.

A third embodiment of the present invention has a synchronous motor 18 in place of the asynchronous motor 18 of the second preferred embodiment. A rotational speed resetting and a relevant synchronization and regulation in the print-off phase are accomplished, according to the second embodiment, for example, in the drive control unit 46.

In a fourth preferred embodiment, a drive motor 18, and particularly a synchronous motor 18, is provided, which drive motor 18 is optionally speed-controlled in a first mode, for the inking unit 08 in print-off and in a second mode can be regulated with respect to torque, for the inking unit 08 in print-on. For speed control, the drive control unit 46 and the drive motor 18 preferably again have an inner control circuit, which, in a manner similar to that of the second embodiment, comprises a reset for an external angular sensor 47 or for a sensor system which is internal to the motor. When synchronous motors 18 are used, several such synchronous motors 18 in a printing unit 01 can be assigned a shared frequency transformer or converter.

A further improvement on the fourth preferred embodiment of the present invention, that is advantageous in terms of versatility, but which is more complicated, involves configuring the drive motor 18 as a servomotor 18 that can optionally be position and torque-controlled. In other words motor 18 can be a three-phase alternating current synchronous motor with a device that allows the relevant rotational position or the formed rotational angle to be determined based upon an initial position of the rotor. The reporting of the rotational position can be accomplished via an angular sensor, such as, for example, a potentiometer, a resolver, an incremental position transducer or an encoder. In this embodiment, each drive motor 18 is equipped with its own frequency transformer or converter.

In the case of a drive motor 18 that is implemented in the manner of the second, third, or especially the fourth embodiment, and which can be at least speed-synchronized, and especially can be speed-controlled, the drive control unit 46 is advantageously in signal connection with a so-called virtual control axis, in which an electronically generated control axis position F rotates. The rotating control axis position F serves in synchronization, with respect to the correct angular position and its temporal change, angular velocity F, in mechanically independent drive motors of units that are assigned to the same web, and especially drive motors of individual printing group cylinders or groups of printing group cylinders, and/or the drive of a folding unit. In the operating mode, in which the inking unit 08 is to be actuated in synchronization with respect to the speed of the forme cylinder 07, a signal connection with the virtual control axis can thus supply the information on machine rate or speed to the drive control unit 46.

Preferably, in the actuation of the second distribution cylinder 12.2 via the drive motor 18, the process is thus that when the inking unit 08 is running, but is in the print-off position, wherein the application rollers 11 are disengaged, the drive motor 18 is actuated in a speed-controlled or regulated manner. When the machine is running, as soon as the inking unit 08, and specifically the application rollers 11 have been adjusted to the print-on position, the speed regulation or control is intentionally discontinued. In other words, a speed is no longer maintained. Instead, the drive motor 18 is operated in the remainder of the process with respect to torque, such as, for example, at a predetermined electrical output, and/or with respect to a torque that can be adjusted at the controller of a drive motor 18, especially an asynchronous motor 18. The torque to be adjusted, or the output to be adjusted, is, for example, chosen to be lower than a threshold torque that would lead to a first rotation, under slip of the actuated second distribution cylinder 12.2 with an interacting roller 13 that is engaged but which is fixed with respect to rotation.

The load characteristics of a drive motor 18, which is configured as an asynchronous motor 18, comply with the behavior which is intended for this purpose in such a manner that with an increasing load, a frequency decrease, with a simultaneous increase in drive torque, takes place. If, for example, a great deal of drive energy, and thus of circumferential speed originating from the forme cylinder 07, is lost in the friction gearing between the forme cylinder 07 and the second distribution cylinder 12.2, so that the load on the drive motor 18 increases, then the increased torque is provided at a reduced frequency. Conversely, a low level of torque is transmitted by the drive motor 18, so that it runs quasi unloaded when sufficient energy is transmitted via the friction gearing to the distribution cylinder 12.2.

While preferred embodiments of the inking systems of a printing press and a method for operating an inking system, in accordance with the present invention have been set forth fully and completely hereinabove, it will be apparent to one of skill in the art that changes in, for example, the structure of the printing cylinders, the type of web being printed, and the like could be made without departing from the true spirit and scope of the present invention which is accordingly to be limited only by the appended claims.

What is claimed is:

1-41. (canceled)

42. An inking unit for a printing press comprising:
a forme cylinder;
means for driving said forme cylinder for rotational movement;
a roller train in said inking unit;
a first distribution cylinder in said roller train and proximate said forme cylinder;
a second distribution cylinder in said roller train and remote from said forme cylinder; and
a distribution cylinder drive motor usable to rotatably drive one of said first and second distribution cylinders, the other of said first and second distribution cylinders being rotatably driven solely by frictional contact with adjacent ones of rollers in said roller train.

43. The inking unit of claim 42 wherein said first and second distribution rollers are arranged in series in said roller train and further including an angular position-controlled drive motor as said means for driving said forme cylinder for rotational movement, said other of said first and second distribution cylinders being unconnected with said distribution cylinder drive motor and said forme cylinder drive motor.

44. The inking unit of claim 42 wherein said second distribution cylinder is driven by said distribution cylinder drive motor and said first distribution cylinder is driven by said frictional contact.

45. The inking unit of claim 42 further including a distribution cylinder drive motor control unit usable to operate said distribution cylinder drive motor, at least during a printing operation of the printing press and when said inking unit is in a print-on position, in one of a controlled and regulated manner to maintain one of a preset electrical output and an adjustable torque to be supplied to said distribution cylinder drive motor.

46. The inking unit of claim 45 wherein during said printing operation in said print-on position, said distribution cylinder drive motor is actuated at a free speed determined by friction with adjacent rollers in said roller train.

47. The inking unit of claim 42 further including an angular position-controlled drive motor for said forme cylinder and wherein said distribution cylinder drive motor is mechanically independent from said angular position-controlled forme cylinder drive motor.

48. The inking unit of claim 42 further including a distribution cylinder drive motor control unit adapted to control said distribution cylinder drive motor, during operation of said inking unit in a print-off position, in terms of at least one of its output and torque.

49. The inking unit of claim 48 wherein a single predetermined value for said at least one of said output and torque is preset.

50. The inking unit of claim 48 wherein for two different production rates of the printing press, two predetermined value of said at least one of said output and torque are preset.

51. The inking unit of claim 48 further wherein a dependency between a predetermined value of one of said output and said torque of said distribution cylinder drive motor and a production rate of said printing press is preset.

52. The inking unit of claim 42 further including a distribution cylinder motor drive control unit usable, during operation of said printing press and when said inking unit is in a print-off position, to control said distribution cylinder drive motor in terms of a preset speed.

53. The inking unit of claim 52 further including a speed reset feature, representative of one of an actual speed of said distribution cylinder and said distribution cylinder drive motor, is provided.

54. The inking u nit of claim 52 further including a target frequency for activation of said distribution cylinder drive motor, said target frequency being preset in said drive control unit.

55. The inking unit of claim 54 further wherein a dependency between said target frequency and a production rate of said printing press is preset.

56. The inking unit of claim 42 wherein said distribution cylinder drive motor is an asynchronous motor.

57. The inking unit of claim 42 wherein said distribution cylinder drive motor is a synchronous motor.

58. The inking unit of claim 42 wherein said distribution cylinder drive motor is a servomotor.

59. The inking unit of claim 42 wherein said distribution cylinder drive motor is controllable in a first mode with respect to a presetting of one of a speed and a frequency and in a second mode with respect to an output and a torque.

60. The inking unit of claim 42 further including means for driving said first and second distribution cylinders for oscillating motion using a shared oscillation gearing.

61. The inking unit of claim 60 wherein said distribution cylinder drive motor provides said oscillation gearing.

62. The inking unit of claim 42 wherein said other of said first and second distribution cylinders driven rotatably by friction further includes a transmission means usable to transform said rotation of said other of said first and second distribution cylinders into axial motion and absent a mechanical drive connection to said one of said first and second distribution cylinders.

63. The inking unit of claim 42 further including an oscillation drive for said first and second distribution cylinders and wherein said distribution cylinder drive motor and said oscillation drive are configured as an inking unit module having a module side frame which is structurally separate from a side frame supporting said forme cylinder.

64. The inking unit of claim 63 wherein said module side forme is movable on said forme cylinder supporting side frame with respect to said forme cylinder.

65. The inking unit of claim 42 further including a distribution cylinder drive motor drive control unit and wherein, at least during a printing operation of said printing press when said inking unit is in a print-on position, said distribution cylinder drive motor is one of controlled and regulated with respect to one of a preset output and an adjustable torque.

66. The inking unit of claim 42 wherein said distribution cylinder drive motor is one of operation controlled and regulated to a constant, preset torque during multiple revolutions of said distribution cylinder.

67. The inking unit of claim 42 wherein, during a print operation of said printing press and in a print-on position of said inking unit, a constant torque is preset for said distribution cylinder drive motor.

68. The inking unit of claim 42 wherein, during a print operation of said printing press and in a print-on position of said inking unit, said distribution cylinder drive motor is operable at a free speed, up to a maximum speed.

69. The inking unit of claim 42 wherein said means for driving said forme cylinder is an angular position-controlled drive motor which is mechanically separate from said distribution cylinder drive motor.

70. The inking unit of claim 69 wherein said angular position-controlled drive motor is unconnected to other cylinders in said printing press.

71. The inking unit of claim 69 further including a transfer cylinder in said printing press and defining a cylinder pair with said forme cylinder, said angular position-controlled drive motor being allocated to said cylinder pair.

72. The inking unit of claim 1 wherein said inking unit is arranged in a printing group of a web-fed rotary printing press.

73. The inking unit of claim 72 wherein said printing group is a component of a blanket-to-blanket printing unit.

74. A method for operating an inking unit of a printing press including:
providing a forme cylinder in the printing press;
providing a roller train in said inking unit including at least a first distribution cylinder and a second distribution cylinder;
locating said first distribution cylinder proximate said forme cylinder and locating said second distribution cylinder remote from said forme cylinder;
providing a distribution cylinder drive motor and using said distribution cylinder drive motor for rotatably driving one of said at least first and second distribution cylinders; and
rotatably actuating another of said at least first and second distribution cylinders solely by frictional engagement with adjacent rollers in said roller train.

75. The method of claim 74 further including controlling said distribution cylinder drive motor, at least during a print operation and when said inking unit is in a print-on position, for maintaining one of a preset electrical output and an adjustable torque being supplied by said drive motor.

76. The method of claim 75 further including providing an angular position-controlled drive motor for said forme cylinder and maintaining said forme cylinder drive motor mechanically independent from said distribution cylinder drive motor.

77. The method of claim 74 further including providing said roller train as a single-train roller inking unit.

78. The method of claim 74 further including positioning said at least first and second distribution cylinders arranged serially in said single-train roller inking unit.

79. The method of claim 74 further including operating said distribution cylinder drive motor at a free speed up to a maximum speed.

80. The method of claim 74 further including using a predetermined torque as a command value for one of controlling and regulating said distribution cylinder drive motor.

81. The method of claim 74 further including operating said distribution cylinder drive motor without one of a preset speed and an angular position during print operation of said printing press and in a print-on position.

82. The method of claim 74 further including operating said distribution cylinder drive motor at a free speed and maintaining a constant torque during print operation of said printing press and in a print-on position.
